(19) United States
(12) Patent Application Publication
(10) Pub. No.: US 2025/0338043 A1
(43) Pub. Date: Oct. 30, 2025

(54) PHOTOELECTRIC CONVERSION DEVICE AND APPARATUS

(71) Applicant: CANON KABUSHIKI KAISHA, Tokyo (JP)

(72) Inventors: Takanori Suzuki, Tokyo (JP); Hideo Kobayashi, Tokyo (JP); Daisuke Yoshida, Kanagawa (JP)

(21) Appl. No.: 19/188,222

(22) Filed: Apr. 24, 2025

(30) Foreign Application Priority Data
Apr. 30, 2024 (JP) 2024-074042

(51) Int. Cl. H04N 25/78; H04N 25/68

(52) U.S. Cl. CPC H04N 25/78; H04N 25/68

(57) ABSTRACT

A photoelectric conversion device including a pixel array, signal lines including first and second signal lines, readout circuits including first, second, third and fourth circuits and arranged to be larger in number than the signal lines, and a switching circuit is provided. The first circuit outputs a signal based on signals supplied to the first and second circuits, the third circuit is outputs a signal based on signals supplied to the third and fourth circuits, and the switching circuit switch a setting between a first setting at which the switching circuit connects the first signal line to the first circuit and connects the second signal line to the second circuit, and a second setting at which the switching circuit connects the first signal line to the third circuit and connects the second signal line to the fourth circuit.

### BACKGROUND OF THE INVENTION

### Field of the Invention

The present disclosure relates to a photoelectric conversion device and an apparatus.

### Description of the Related Art

A photoelectric conversion device is used for an image input apparatus such as a digital camera. Japanese Patent Laid-Open No. 2009-213012 discloses a technique in which a plurality of analog circuits arranged in a column processing unit have a redundancy configuration to remedy a defect of the analog circuit and improve a decrease in yield caused by the defect.

### SUMMARY OF THE INVENTION

An analog circuit sometimes performs an arithmetic process such as addition or subtraction on an analog signal read out between a plurality of analog circuits. Japanese Patent Laid-Open No. 2009-213012 discloses switching from a defective analog circuit to a non-defective analog circuit, but does not consider switching of an analog circuit when analog signals read out by a plurality of analog circuits are supplied to one analog circuit to perform an arithmetic process.

Some embodiments of the present disclosure provide a technique advantageous for improving the redundancy of a photoelectric conversion device.

According to some embodiments, a photoelectric conversion device comprising: a pixel array including a plurality of pixels arranged to constitute a plurality of rows and a plurality of columns; a plurality of signal lines configured to read out a signal from the pixel array; a plurality of readout circuits arranged to be larger in number than the plurality of signal lines; and a switching circuit configured to switch connections between the plurality of signal lines and the plurality of readout circuits, wherein the plurality of readout circuits include a first readout circuit, a second readout circuit, a third readout circuit, and a fourth readout circuit, the first readout circuit is configured to output a signal based on signals respectively supplied to the first readout circuit and the second readout circuit, and the third readout circuit is configured to output a signal based on signals respectively supplied to the third readout circuit and the fourth readout circuit, the plurality of signal lines include a first signal line and a second signal line, and the switching circuit is configured to switch a setting between a first setting at which the switching circuit connects the first signal line to the first readout circuit and connects the second signal line to the second readout circuit, and a second setting at which the switching circuit connects the first signal line to the third readout circuit and connects the second signal line to the fourth readout circuit, is provided.

Further features of the present invention will become apparent from the following description of exemplary embodiments (with reference to the attached drawings).

### BRIEF DESCRIPTION OF THE DRAWINGS

FIG. 1 is a view showing an example of the arrangement of a photoelectric conversion device according to an embodiment;

FIG. 2 is a view for explaining the default setting of the photoelectric conversion device in FIG. 1;

FIG. 3 is a circuit diagram showing an example of the arrangement of the switching circuit of the photoelectric conversion device in FIG. 1;

FIG. 4 is a circuit diagram for explaining an arithmetic process between the readout circuits of the photoelectric conversion device in FIG. 1;

FIGS. 5A to 5C are views showing examples of the redundancy setting of the photoelectric conversion device in FIG. 1;

FIGS. 6A and 6B are views showing examples of the redundancy setting of the photoelectric conversion device in FIG. 1;

FIG. 7 is a view showing a modification of the photoelectric conversion device in FIG. 1;

FIG. 8 is a view showing a modification of the photoelectric conversion device in FIG. 1;

FIG. 9 is a view showing a modification of the photoelectric conversion device in FIG. 1; and

FIG. 10 is a view showing an example of the arrangement of an apparatus incorporating the photoelectric conversion device in FIG. 1.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

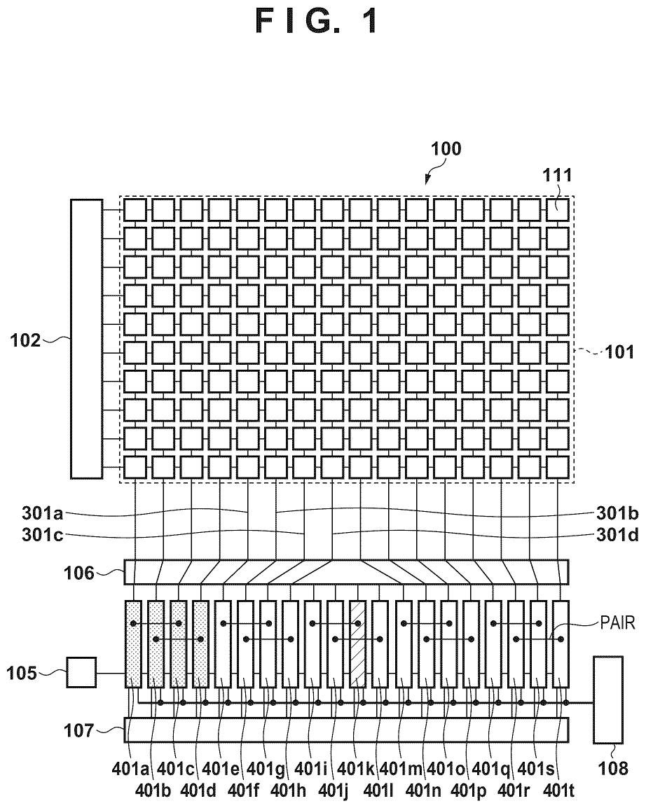

A photoelectric conversion device according to an embodiment of the present disclosure will be explained with reference to FIGS. 1 to 9. FIG. 1 is a view showing an example of the arrangement of a photoelectric conversion device 100 according to the embodiment. The photoelectric conversion device 100 includes a pixel array 101, a plurality of signal lines 301, a plurality of readout circuits 401, and a switching circuit 106. The photoelectric conversion device 100 also includes a vertical scanning circuit 102, a counter circuit 105, a horizontal scanning circuit 107, and a digital processing circuit 108.

In the pixel array 101, a plurality of pixels 111 each of which includes a photoelectric conversion element and outputs an analog signal are arranged to constitute a plurality of rows and a plurality of columns. In the arrangement shown in FIG. 1, the pixels 111 are arranged on 10 rows×16 columns in the pixel array 101 for descriptive convenience. However, a larger number of pixels 111 can be arranged in the pixel array 101 in practice. In a description of the arrangement shown in FIG. 1, the pixels 111 arranged on odd-numbered columns and the pixels 111 arranged on even-numbered columns are sensitive to light beams of different colors. For example, the pixels 111 arranged on odd-numbered columns include the pixels 111 having a color filter that transmits red light, and the pixels 111 arranged on even-numbered columns include the pixels 111 having a color filter that transmits blue light.

The vertical scanning circuit 102 selects the pixels 111 to output signals. More specifically, the vertical scanning circuit 102 selects a row of the pixels 111 to output signals. Then, analog signals are output from the pixels 111 of the selected row to the signal lines 301.

The signal lines 301 are arranged to read out signals from the pixel array 101. In the arrangement shown in FIG. 1, each signal line 301 is shared by the pixels 111 aligned in the column direction. Since the number of pixel columns is 16, 16 signal lines 301 are arranged in the lateral direction. Although not shown in FIG. 1, a constant current circuit can be arranged on the signal line 301 to obtain an output signal from the pixel 111. Further, a circuit that turns off the constant current circuit at a predetermined timing may be arranged on the signal line 301 to reduce the power consumption of the photoelectric conversion device 100. A circuit that clips the lower limit level or upper limit level of the voltage of an analog signal supplied to the signal line 301 may be arranged on the signal line 301 to limit an input range to the subsequent readout circuit 401. When a specific signal line out of the signal lines 301 is indicated, a suffix will be attached to a reference numeral, like the signal line 301“a”. When the signal lines 301 need not be discriminated, they will be simply referred to as “301”. This also applies to the remaining constituent elements.

The readout circuit 401 is a circuit that processes signals (analog signals) output from the pixels 111 to the signal line 301 within a column. In the embodiment, a circuit for performing an arithmetic process on signals supplied from different columns of the pixel 111 is arranged in the readout circuit 401. For example, the readout circuit 401f is configured to output a signal based on a signal supplied to the readout circuit 401f or signals respectively supplied to the readout circuits 401f and 401h, details of which will be described later. A combination of the readout circuits 401, like the readout circuits 401f and 401h, is shown as a “pair” in FIG. 1. The readout circuit 401 includes, for example, an A/D converter and a memory, and converts an analog signal supplied from the pixel 111 into a digital signal.

In the arrangement shown in FIG. 1, 20 readout circuits 401 are arranged for 16 signal lines 301. That is, the readout circuits 401 are arranged more in number than the signal lines 301. For example, the readout circuits 401a to 401d out of the readout circuits 401 are arranged as redundancy circuits for remedying a defect when a defect is generated in some readout circuits 401. FIG. 1 shows connection relationships between the signal lines 301 and the readout circuits 401 when a defect is generated in the readout circuit 401k and the readout circuits 401a to 401d set as redundancy circuits are used.

As the above-mentioned pair, the readout circuits 401e and 401g, the readout circuits 401f and 401h, the readout circuits 401i and 401k, the readout circuits 401j and 401l, the readout circuits 401m and 401o, the readout circuits 401n and 401p, the readout circuits 401q and 401s, and the readout circuits 401r and 401t are combined in FIG. 1. As for the readout circuits 401a to 401d arranged as redundancy circuits, the readout circuits 401a and 401c, and the readout circuits 401b and 401d are paired. In some cases, a pair of the readout circuits 401 between odd-numbered columns, such as the readout circuits 401e and 401g, will be called an odd-numbered column pair, and a pair of the readout circuits 401 between even-numbered columns, such as the readout circuits 401f and 401h, will be called an even-numbered column pair. The readout circuit 401 to which signals from the pixels 111 of an even-numbered column are supplied is arranged between paired odd-numbered columns because odd-numbered columns and even-numbered columns include the pixels 111 sensitive to light beams of different colors, as described above. This prevents the respective readout circuits 401 from performing arithmetic processes within the circuits based on a plurality of signals supplied from the pixels 111 sensitive to light beams of different colors, and outputting signals corresponding to the arithmetic results.

The arithmetic processes performed within the circuits are an addition process or subtraction process of the voltage of an analog signal, and the like. For example, the readout circuit 401f performs an addition process or a subtraction process based on an analog signal supplied to the readout circuit 401f and an analog signal supplied to the readout circuit 401h. Although details of the arrangement of the readout circuit 401 will be described later, the readout circuit 401 is configured to add analog signals by capacitive coupling at the input position of the readout circuit 401 in the embodiment. The readout circuit 401 includes an A/D-converter, and temporarily holds digitally converted digital data in the internal memory of the readout circuit 401. The horizontal scanning circuit 107 controls the transfer timing of the digital data held in the internal memory of the readout circuit 401. The digital data held in the readout circuit 401 of each column are sequentially transferred to the subsequent digital processing circuit 108. In the digital processing circuit 108 and subsequent units, an additional process, data compression, and the like can be executed on the transferred digital data.

Next, as for the readout circuit 401 including an analog circuit, a method of improving the redundancy by remedying of a defective circuit and improving the yield of the photoelectric conversion device 100 will be explained. The characteristics of the readout circuit 401 may become locally poorer than those of the other neighboring readout circuits 401 owing to manufacturing variations of a transistor or capacitance included in the circuit. The readout circuit 401 exhibiting an obvious defect at function level may exist due to opening or short-circuiting of a wiring pattern caused by mixing of a foreign substance. Even when the characteristics of the readout circuit 401 fall within a range of assumed variations, the driving force of the transistor that greatly influences analog characteristics may be weaker (or stronger), compared to the adjacent readout circuit 401. In this case, a faint line defect visible on an obtained image may appear. If an image test is conducted and the defect stands out to a certain degree, the photoelectric conversion device 100 cannot be accepted as a non-defective, decreasing the yield.

To solve this, when the characteristics of a given readout circuit 401 degrade, and a defect such as a line defect arising from the readout circuit 401 is determined, the switching circuit 106 switches connection relationships between the signal lines 301 and the readout circuits 401 in the photoelectric conversion device 100 according to the embodiment. At this time, the use of both the readout circuit 401 poor in characteristics, and the readout circuit 401 paired with the readout circuit 401 poor in characteristics is simultaneously stopped, and the readout circuits 401 arranged as redundancy circuits are used.

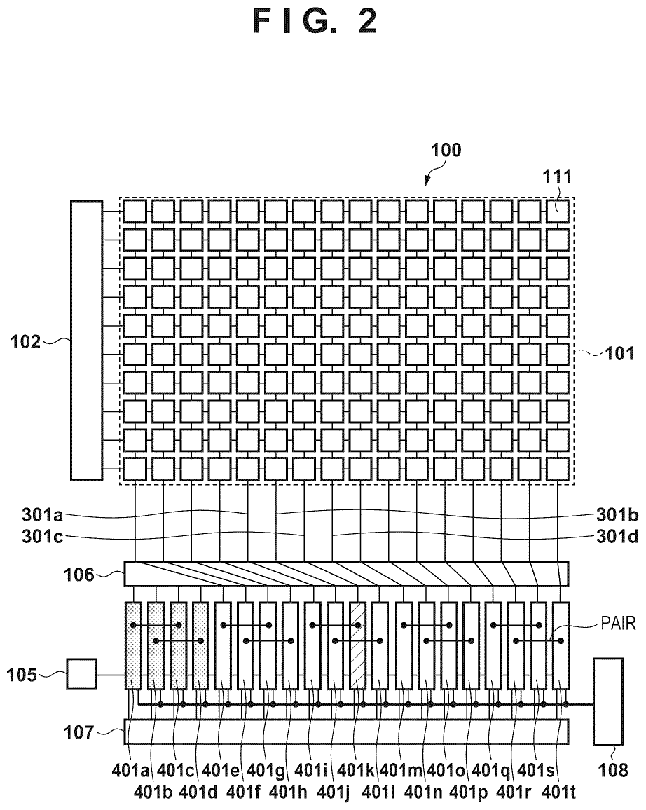

The gist of the embodiment will be explained with reference to FIGS. 1 and 2. FIG. 2 shows an arrangement at a default setting in which the readout circuits 401a to 401d set as redundancy circuits are not used. In contrast, FIG. 1 shows an arrangement at a redundancy setting in which the readout circuits 401a to 401d set as redundancy circuits are used. It is assumed in FIGS. 1 and 2 that the readout circuit 401k out of the readout circuits 401a to 401t is determined not to satisfy predetermined characteristics. At the default setting shown in FIG. 2, the readout circuits 401a to 401d of four columns at the left end out of the readout circuits 401a to 401t are redundancy circuits, are not connected to any of the signal lines 301, and are not used. The layout of the readout circuits 401 set as redundancy circuits is not limited to the example shown in FIGS. 1 and 2, and the readout circuits 401 can be arranged at proper positions.

The switching circuit 106 is arranged between the signal lines 301 and the plurality of readout circuits 401, and switches connections between the signal lines 301 and the readout circuits 401. In FIGS. 1 and 2, solid lines drawn on the switching circuit 106 visually represent connections between the 16 signal lines and readout circuits out of the 20 readout circuits 401a to 401t. For example, FIG. 2 shows that the signal lines 301 are not connected to the readout circuits 401a to 401d, and the four readout circuits 401a to 401d (redundancy circuits) at the left end are not used. When a test is conducted at the default setting shown in FIG. 2 and it is confirmed that the characteristics of the 16 readout circuits 401 used have no problem, the photoelectric conversion device 100 can be handled as a non-defect. To the contrary, when it is determined at the default setting that there is the readout circuit 401 poor in characteristics, for example, when the readout circuit 401 has a problem in FIG. 2, the switching circuit 106 is controlled to switch the setting to the redundancy setting as shown in FIG. 1 and use the photoelectric conversion device 100. This can make the photoelectric conversion device 100 a non-defect.

More specifically, in FIGS. 1 and 2, a signal supplied from the signal line 301a and a signal supplied from the signal line 301c out of the signal lines 301 are subjected to an arithmetic process within the readout circuits 401. At the default setting shown in FIG. 2, the switching circuit 106 connects the signal line 301a to the readout circuit 401i, and the signal line 301c to the readout circuit 401k. When a line defect (luminance difference visible by an output difference from neighboring columns) appears in the pixel column using the readout circuit 401k as a result of a test, the characteristics of the readout circuit 401k are determined to be poorer than those of the neighboring readout circuits 401.

To solve this, the switching circuit 106 is controlled using an external input register or the like, and the switching circuit 106 switches the setting from the default setting to the redundancy setting for remedying the defect of the readout circuit 401k, as shown in FIG. 1. By controlling the switching circuit 106, the connection relationships between the signal lines 301 and the readout circuits 401 are switched to implement a remedy by the redundancy circuits. The switching circuit 106 connects the signal line 301a to the readout circuit 401e, and the signal line 301c to the readout circuit 401g. The switching circuit 106 stops the use of, as the connection destinations of the signal lines 301, not only the readout circuit 401k poor in characteristics, but also the readout circuit 401i paired with the readout circuit 401k, and sequentially shifts the readout circuits 401 to which the signal lines 301 are connected. By this control, the signal lines 301 are connected to the readout circuits 401a to 401d arranged as redundancy circuits on four columns at the left end out of the readout circuits 401, compensating for the unused readout circuits 401i to 401l of four columns. At the redundancy setting shown in FIG. 1, a test is conducted again, and if it is confirmed that an image has no problem, the photoelectric conversion device 100 can be made a non-defect on the premise of using the redundancy setting.

As shown in FIG. 2, at the default setting, the switching circuit 106 connects the signal line 301b to the readout circuit 401j, and the signal line 301d to the readout circuit 401l. The readout circuit 401j is arranged between the readout circuit 401k poor in characteristics and the readout circuit 401i paired with the readout circuit 401k. Here, like the redundancy setting shown in FIG. 1, the use of not only a pair including the defective readout circuit 401, but also a pair including the readout circuit 401 sandwiched between the paired readout circuits 401 including the defective readout circuit 401 may be stopped at the redundancy setting. Thus, the switching circuit 106 connects the signal line 301b to the readout circuit 401f, and the signal line 301d to the readout circuit 401h. When the use of all the readout circuits 401i to 401l of four columns is stopped as shown in FIG. 1, the switching circuit 106 is configured to shift connections between the signal lines 301 and the readout circuits 401 at once for four columns. Therefore, a control pulse for switching connections between the signal lines 301 and readout circuits 401 can be shared, suppressing the circuit scale of the switching circuit 106 and the like. The layout of the readout circuits 401 has a merit of avoiding a risk at which a wiring pattern connecting the paired readout circuits 401 including the readout circuit 401 poor in characteristics couples with an analog signal of the readout circuit 401 sandwiched between the paired readout circuits 401 including the readout circuit 401 poor in characteristics and affects it.

At the redundancy setting, the connection relationships of the readout circuits 401e to 401h arranged on the side of the readout circuits 401a to 401d arranged as redundancy circuits with respect to the pair including the defective readout circuit 401k, and the pair including the readout circuit 401j sandwiched between the paired readout circuits 401 including the readout circuit 401k are sequentially shifted. In contrast, the connection relationships between the signal lines 301 and the readout circuits 401m to 401t arranged on a side opposite to the readout circuits 401a to 401d with respect to the pair including the defective readout circuit 401k, and the pair including the readout circuit 401j sandwiched between the paired readout circuits 401 including the readout circuit 401k do not change from the default setting. In other words, the readout circuit 401k poor in characteristics is arranged between the readout circuit 401j sandwiched between the paired readout circuits 401 including the readout circuit 401k, and the readout circuits 401m to 401t.

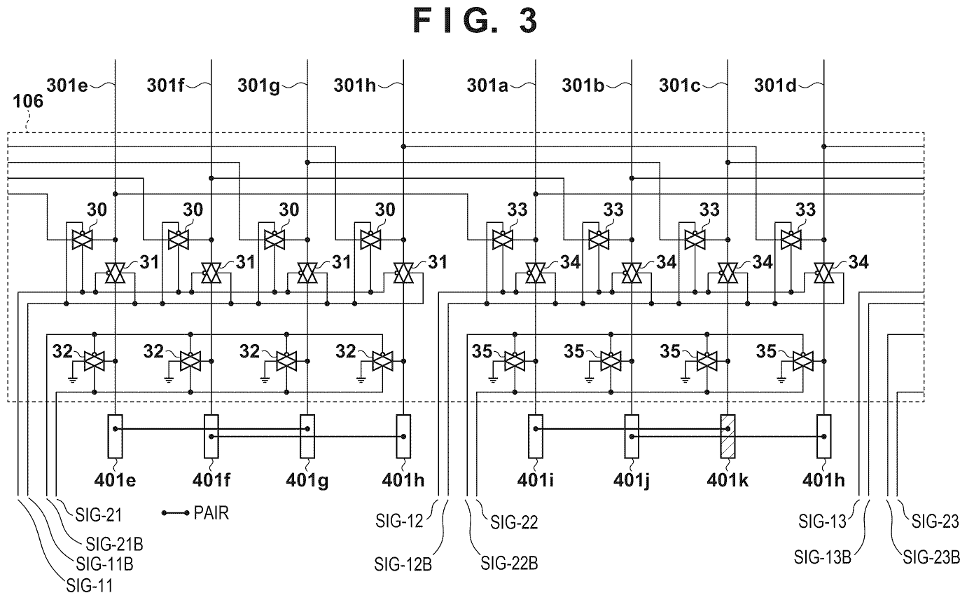

FIG. 3 is a circuit diagram for explaining an example of the circuit arrangement of the switching circuit 106 for implementing the above-described default setting and redundancy setting. Pairs of the readout circuits 401 in which an arithmetic process is performed within the circuits based on signals supplied from a plurality of signal lines are set, and the connection relationships between the signal lines 301 and the readout circuits 401 can be controlled for four columns. Switching between the default setting and the redundancy setting can be controlled using an external input register. Upon receiving an external input register value, a decoder (not shown) in the switching circuit 106 generates a control pulse for four columns, and can implement different connections for four columns. When the characteristics of a given readout circuit 401 degrade, the switching circuit 106 having the above circuit arrangement stops the use of the readout circuits 401 of four columns in the above-mentioned combination including the readout circuit 401 poor in characteristics. The readout circuits 401 of four columns including the readout circuit 401 poor in characteristics are skipped, and the connection relationships between the signal lines 301 and the readout circuits 401 can be switched. FIG. 3 shows part of the switching circuit 106 corresponding to the readout circuits 401e to 401l. Part of the switching circuit 106 corresponding to the remaining readout circuits 401 is not shown, but has a similar control arrangement for every four columns.

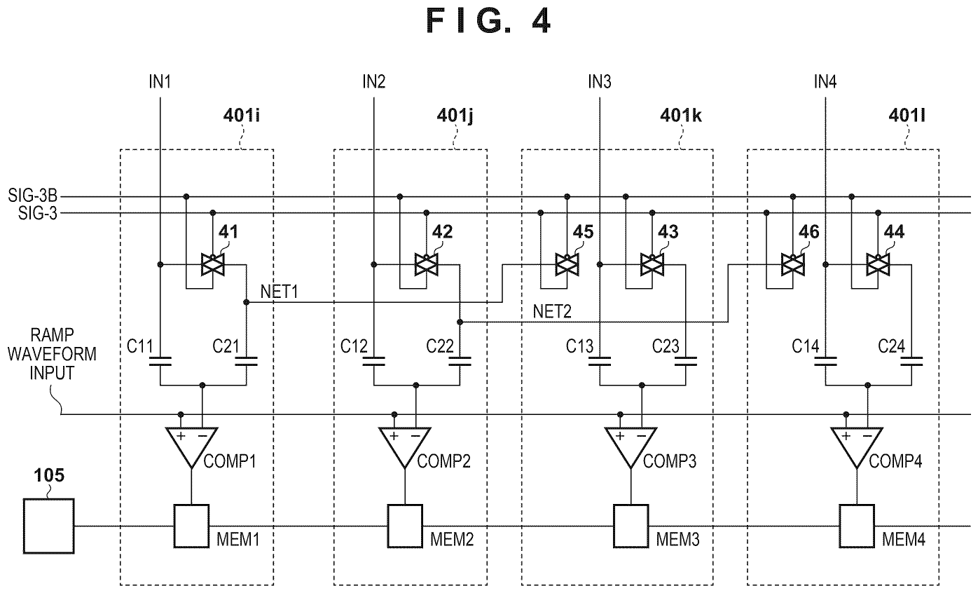

First, at the default setting, control signals SIG-11, SIG-12, and SIG-13 are set to Lo level, and control signals SIG-11B, SIG-12B, and SIG-13B serving as their inverted signals are set to Hi level. In response to this, switches 30 and switches 33 are turned off (non-conductive), and switches 31 and switches 34 are turned on (conductive). At the same time, control signals SIG-21, SIG-22, and SIG-23 are set to Lo level, and control signals SIG-21B, SIG-22B, and SIG-23B serving as their inverted signals are set to Hi level. In response to this, switches 32 and switches 35 are turned off. In FIG. 3 and FIG. 4 to be described later, a signal with a suffix “B” to the reference numeral of a control signal represents the inverted signal of a control signal without the suffix. A description of the state of the inverted signal will be omitted below.

At the redundancy setting when the characteristics of the readout circuit 401k degrade, the control signals SIG-11 and SIG-12 are set to Hi level to turn on the switches 30 and 33 and turn off the switches 31 and 34. By this operation, the connections of the readout circuits 401 to the signal lines 301 can be shifted left by four columns.

That is, at the default setting, the switching circuit 106 connects the signal line 301a to the readout circuit 401i, the signal line 301b to the readout circuit 401j, the signal line 301c to the readout circuit 401k, and the signal line 301d to the readout circuit 401l. Also, the switching circuit 106 connects the signal line 301e to the readout circuit 401e, the signal line 301f to the readout circuit 401f, the signal line 301g to the readout circuit 401g, and the signal line 301h to the readout circuit 401h. Although not shown in FIG. 3, the signal lines 301 are not connected to the readout circuits 401a to 401d arranged as redundancy circuits.

In contrast, at the redundancy setting, the connection destinations of the signal lines 301 are shifted left by four columns. The switching circuit 106 connects the signal line 301a to the readout circuit 401e, the signal line 301b to the readout circuit 401f, the signal line 301c to the readout circuit 401g, and the signal line 301d to the readout circuit 401h. Although not shown in FIG. 3 (shown in FIG. 1), the signal lines 301e to 301h are connected to the readout circuits 401a to 401d arranged as redundancy circuits left on four columns.

In the arrangement shown in FIG. 3, the control signal SIG-22 is set to Hi level at the redundancy setting to turn on the switches 35. In response to this, the level of input signals to the readout circuits 401i to 401l that are not connected to the signal lines 301 and are not used at the redundancy setting is fixed to GND level. The input of the readout circuit 401, out of the plurality of readout circuits 401, which is not connected to any of the signal lines 301 is connected to a fixed potential regardless of GND level. This can suppress generation of a through current arising from a change of the input to a floating state. When the input level is fixed, the readout circuits 401, the use of which is stopped, can be operated without influencing the characteristics of the photoelectric conversion device 100. Operating the readout circuits 401, the use of which is stopped, means executing A/D conversion even on a GND-level input in the readout circuit 401, the use of which is stopped in the embodiment. If the power of only the four readout circuits 401, the use of which is stopped, is saved, a current flowing through a power supply line or the like may become partially nonuniform and affect the neighboring readout circuits 401. Such a risk can be avoided by operating the readout circuits 401, the use of which is stopped at the redundancy setting. Similarly, the inputs of the readout circuits 401a to 401d arranged as redundancy circuits may be connected to the fixed potential at the default setting. Similarly, the readout circuits 401a to 401d may be operated at the default setting.

FIG. 4 is a circuit diagram showing an example of the arrangement of the readout circuits 401. FIG. 4 exemplifies the readout circuits 401i to 401l, but the remaining readout circuits 401 can also have a similar arrangement. Inputs of signals from the pixels 111 to the readout circuits 401 are represented as input lines IN1 to IN4 that connect the switching circuit 106 and the readout circuits 401.

The readout circuits 401i to 401l shown in FIG. 4 are configured to output digital signals based on analog signals supplied to the respective readout circuits 401. A mode in which the readout circuit 401 A/D-converts a signal supplied to the readout circuit 401 will be sometimes called a normal mode hereinafter. The readout circuit 401i is configured to output not only a digital signal based on an analog signal supplied to the readout circuit 401i, but also a digital signal based on analog signals respectively supplied to the readout circuit 401i and the paired readout circuit 401k. Similarly, the readout circuit 401j is configured to output not only a digital signal based on an analog signal supplied to the readout circuit 401j, but also a digital signal based on analog signals respectively supplied to the readout circuit 401j and the paired readout circuit 401l. A mode in which the readout circuit 401 A/D-converts signals supplied to the readout circuit 401 and the paired readout circuit 401 will be sometimes called a thinning mode hereinafter. The photoelectric conversion device 100 (readout circuit 401) according to the embodiment can operate while switching the setting between the normal mode and the thinning mode.

In the normal mode, the quality of an obtained image is high, but the image data amount becomes large. To reduce the image data amount, a specification capable of switching to a mode (thinning mode) in which the number of readout circuits that perform A/D conversion is thinned to, for example, half is sometimes required. To keep high the quality of an obtained image even in the thinning mode, the readout circuit 401 reads out signals of all columns without thinning signals from the pixels 111. FIG. 4 shows an example of the arrangement in which the readout circuits 401i and 401j execute an addition process of analog voltages serving as signals supplied from the pixels 111.

The readout circuit 401 includes an A/D converter and a memory MEM. The A/D converter is a slope A/D converter that uses a comparator COMP, a counter circuit 105, and a ramp waveform generation circuit (not shown). The comparator COMP compares a ramp wave and an input voltage level. The A/D converter counts clocks that are supplied from the counter circuit 105 in synchronization with the ramp wave. A count value at time when the input voltage level crosses the ramp wave is written in the memory MEM. The A/D converter may be an A/D converter of another type such as a successive comparison or delta-sigma A/D converter.

In the embodiment, signals respectively supplied to the readout circuit 401i and the readout circuit 401k, and signals respectively supplied to the readout circuit 401j and the readout circuit 401l can be added. The readout circuits 401 are constituted by two pairs each of two readout circuits 401 for every four columns. The same circuit arrangement is repeated for the remaining readout circuits 401. FIG. 4 shows the four readout circuits 401 of four columns, that is, the readout circuits 401i to 401l.

Two types of input capacitances, that is, an input capacitance C11 and an input capacitance C21 are arranged in the readout circuit 401. In the normal mode, a control signal SIG-3 is set to Lo level to turn on switches 41, 42, 43, and 44 and turn off switches 45 and 46. In each readout circuit 401, a signal supplied via an input line IN is input to both the input capacitances C11 and C21. That is, a signal input from one signal line 301 is supplied to the readout circuit 401 of one corresponding column, and the process is closed within this column.

In the thinning mode, the control signal SIG-3 is set to Hi level to turn off the switches 41, 42, 43, and 44 and turn on the switches 45 and 46. Then, a signal supplied via the input line IN1 is input to the input capacitance C11 of the readout circuit 401i, and a signal supplied via the input line IN3 is input to the input capacitance C21 of the readout circuit 401i. Similarly, a signal supplied via the input line IN2 is input to the input capacitance C11 of the readout circuit 401j, and a signal supplied via the input line IN4 is input to the input capacitance C21 of the readout circuit 401j. As a result, a signal obtained by combining the signals respectively supplied via the input lines IN1 and IN3 appears at the negative input of the comparator COMP1 of the readout circuit 401i. Similarly, a signal obtained by combining the signals respectively supplied via the input lines IN2 and IN4 appears at the negative input of the comparator COMP2 of the readout circuit 401j. Accordingly, the readout circuits 401i and 401j execute the addition process.

In the embodiment, the level of an analog signal appearing on the negative input side of the comparator COMP, and a ramp wave as a reference voltage on the positive input side of the comparator COMP are respectively supplied and compared. At a timing when the signal levels on the positive and negative input sides of the comparator COMP are reversed, the comparator COMP outputs an inverted signal, and a counter value at time when the inverted signal is output is written in the memory MEM. As a result, the analog signal output from the pixel 111 is converted into a digital signal.

By changing the capacitance ratio between the input capacitance C11 and the input capacitance C21, signals supplied to the two readout circuits 401 can be weighted in the thinning mode. That is, in the arrangement shown in FIG. 4, the readout circuits 401i and 401j can perform a weighted addition process. For example, when the capacitance ratio between the input capacitance C11 and the input capacitance C21 is 2:1, the readout circuit 401i can implement such an arithmetic process that a signal supplied via the input line IN1 influences double an output value after A/D conversion, compared to a signal supplied via the input line IN3. When weighted addition is performed, connection destinations are switched at once for a pair of the readout circuits 401. This facilitates switching because the weight on the input line IN corresponding to a left column can always maintain “2”, like the input line IN1:the input line IN3=2:1. The circuit design can be easy by switching connections between the signal lines 301 and the readout circuits 401 for each pair of the readout circuits 401, like the above-described default setting and redundancy setting, instead of switching them without considering a pair of the readout circuits 401.

In the arrangement shown in FIG. 4, the comparators COMP3 and COMP4 of the readout circuits 401k and 401l are not used in the thinning mode, but may be used. For example, a signal obtained by combining a signal supplied via the input line IN1 and a signal supplied via the input line IN3 is supplied to the comparator COMP3, like the comparator COMP1. Similarly, a signal obtained by combining a signal supplied via the input line IN2 and a signal supplied via the input line IN4 is supplied to the comparator COMP4, like the comparator COMP2. At this time, a ramp waveform input having a slope different from that of a ramp wave supplied to the comparators COMP1 and COMP2 of the readout circuits 401i and 401j is supplied to the positive input sides of the comparators COMP3 and COMP4. Then, A/D conversion may be simultaneously executed at different A/D conversion gains between the readout circuits 401i and 401j and the readout circuits 401k and 401l. For example, different arithmetic processes may be performed between the readout circuits 401i and 401j and the readout circuits 401k and 401l. For example, a signal obtained by subtracting a signal supplied via the input line IN3 from a signal supplied via the input line IN1 may be supplied to the comparator COMP3 of the readout circuit 401k. Similarly, a signal obtained by subtracting a signal supplied via the input line IN4 from a signal supplied via the input line IN2 may be supplied to the comparator COMP4 of the readout circuit 401l. Then, signals can be respectively supplied to simultaneously execute A/D conversion by addition and subtraction. Digital data based on analog signals having undergone the addition process and digital data based on analog signals having undergone the subtraction process can be obtained in the readout circuits 401i and 401j and the readout circuits 401k and 401l.

As described above, when an arithmetic process is performed using a signal supplied to another readout circuit 401, the use of not only the readout circuit 401 poor in characteristics, but also the paired readout circuit 401 is stopped, and the readout circuits 401 are switched to redundancy circuits. As described above, in a case where the characteristics of one of the paired readout circuits 401 are poor, even if only the readout circuit 401 poor in characteristics is disconnected using a switch or the like, the influence of the readout circuit 401 poor in characteristics cannot be completely eliminated and remains in the analog circuit. When, of the paired readout circuits 401, the readout circuit 401 whose characteristics do not degrade is kept used without stopping it, for example, the connection destination of a connection line NET1 shown in FIG. 4 is switched to the readout circuit 401 of another column by using a switch or the like at the redundancy setting. However, the control pulse of the switch for switching the connection destination to the readout circuit 401 of another column changes between Hi level and Lo level. The change of the control pulse may influence the precision of A/D conversion owing to coupling between the control pulse of the switch and an analog signal in the readout circuit 401. As an arithmetic process performed in the readout circuit 401 becomes more complicated, control of keeping using only one of the paired readout circuits 401 and switching the other also becomes more complicated. To prevent this, when supplied signals are transferred between the readout circuits 401 to perform an arithmetic process, the use of a pair of the readout circuits 401 including the defective readout circuit 401 poor in characteristics is stopped, and the connection destinations of the signal lines 301 are switched at once. This arrangement implements the photoelectric conversion device 100 in which the cumbersome of the circuit design and the like is reduced and the redundancy is excellent.

In the above-described embodiment, one block is constituted by arranging one readout circuit 401 in the column direction and the plurality of readout circuits 401 in the row direction. However, the arrangement is not limited to this. For example, the readout circuits 401 may be arranged even in the column direction. In the above description, each signal line 301 is arranged in correspondence with each column of the pixels 111. However, the signal lines 301 may be arranged by a predetermined number of lines in correspondence with each column of the pixels 111 so as to simultaneously read out signals at high speed from the pixels 111 arranged on a plurality of rows. In such a case, the plurality of readout circuits 401 may be arranged in the column and row directions.

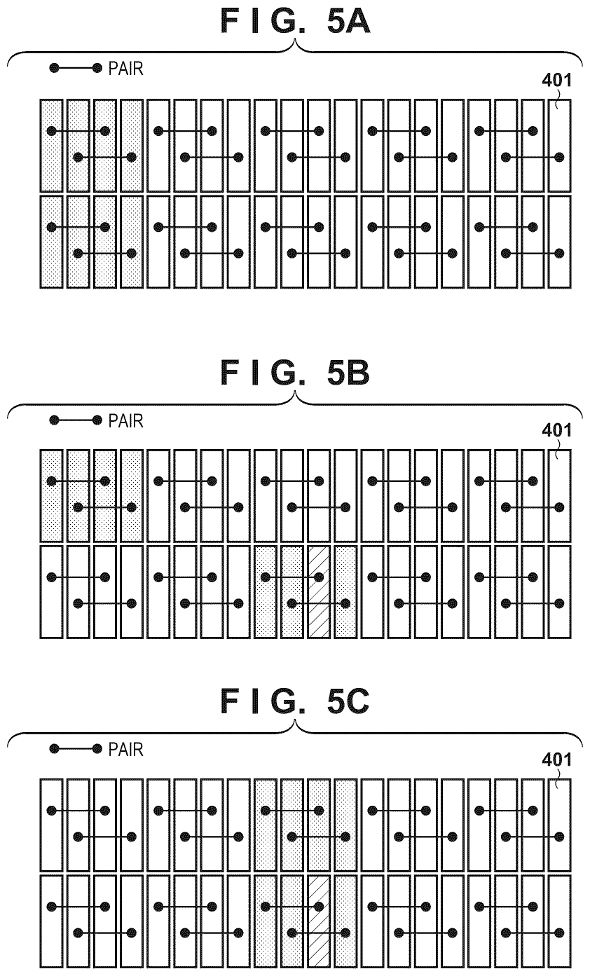

FIGS. 5A to 5C are views for explaining variations of the redundancy setting of the readout circuits 401. In the arrangements shown in FIGS. 5A to 5C, for example, the readout circuits 401 are arranged in two rows in the column direction×20 columns in the row direction in order to simultaneously read out signals from the pixels 111 on two rows×16 columns. Also, FIGS. 5A to 5C show pairs of the readout circuits 401 regarding an arithmetic process, similar to FIG. 1 and the like. In FIGS. 5A to 5C, the dotted readout circuit 401 represents the readout circuit 401 that is not connected to the signal line 301 and is not used, and does not always represent the position of the readout circuit 401 arranged as a redundancy circuit. The hatched readout circuit 401 represents the position of the readout circuit 401 that is poor in characteristics and is not used.

FIG. 5A is a view showing an example of the default setting. The readout circuits 401 on two rows×4 columns at the left end are not used and are assigned as redundancy circuits. If the characteristics of any of the readout circuits 401 do not degrade, the photoelectric conversion device 100 can be used at the default setting without any problem. FIG. 5B shows an example of the use pattern of the readout circuits 401 at the redundancy setting. As described above, the use of four readout circuits 401, that is, a pair of the readout circuits 401 including the readout circuit 401 poor in characteristics, and a pair of the readout circuits 401 including the readout circuit 401 sandwiched between the paired readout circuits 401 including the readout circuit 401 poor in characteristics is stopped. In this case, the readout circuits 401 that are arranged as redundancy circuits and positioned on the same row as that of the readout circuit 401 poor in characteristics are used. An example of the switching circuit 106 that switches connections between the signal lines 301 and the readout circuits 401 from the default setting to the redundancy setting has been described above. FIG. 5C shows an example of the use pattern of the readout circuits 401 at the redundancy setting, which is different from the use pattern shown in FIG. 5B. The readout circuits 401 not used in the use pattern in FIG. 5B are spread even in the column direction. The use of all the readout circuits 401 on the ninth to 12th columns from left is stopped, and redundancy circuits arranged on the first to fourth columns are used.

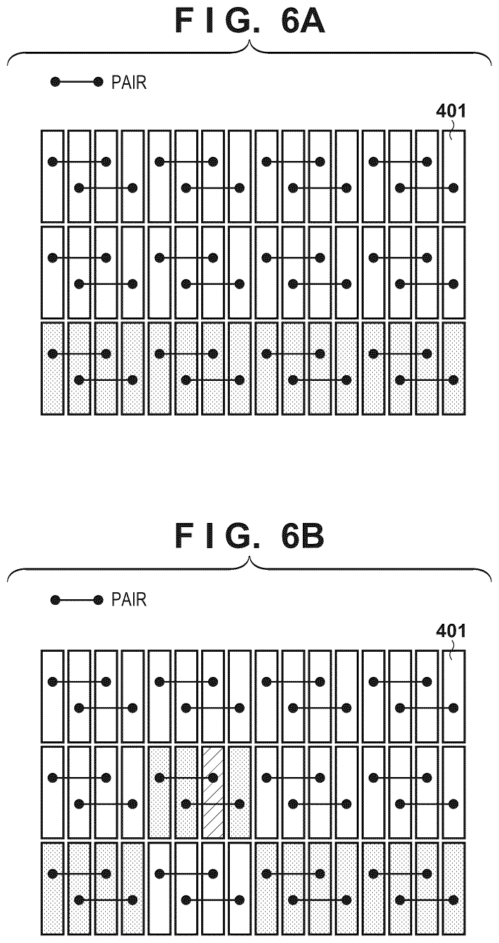

FIGS. 6A and 6B are views for explaining variations of the redundancy setting of the readout circuits 401, similar to FIGS. 5A to 5C. The above-described embodiment has explained an example in which redundancy circuits are arranged in the lateral direction and the switching circuit 106 switches connections between the signal lines 301 and the readout circuits 401 in the column direction. However, redundancy circuits can also be arranged in the longitudinal direction. This is effective when the layout size is large enough because a layout in the column direction becomes long when redundancy circuits are arranged in the longitudinal direction, compared to the lateral direction. Even when redundancy circuits are arranged in the longitudinal direction, the setting is switched to a setting of stopping the use of not only the readout circuit 401 poor in characteristics, but both the paired readout circuits 401 regarding an arithmetic process, and using the readout circuits 401 arranged as redundancy circuits, as described above. In the case where redundancy circuits are arranged in the longitudinal direction, compared to the case where redundancy circuits are arranged in the lateral direction, the distance between the readout circuits 401 that transfer signals becomes long and, for example, noise readily mixes in the signals unless the use of the paired readout circuits 401 is simultaneously stopped to switch them. For this reason, the use of the paired readout circuits 401 including the readout circuit 401 poor in characteristics is stopped to switch them to redundancy circuits.

FIG. 6A is a view showing an example of the default setting. In FIG. 6A, the readout circuits 401 arranged on columns at the lower end are not used and assigned as redundancy circuits. If the characteristics of any of the readout circuits 401 do not degrade, the photoelectric conversion device 100 can be used at the default setting without any problem. FIG. 6B shows an example of the use pattern of the readout circuits 401 at the redundancy setting. The use of four readout circuits 401, that is, a pair of the readout circuits 401 including the readout circuit 401 poor in characteristics, and a pair of the readout circuits 401 including the readout circuit 401 sandwiched between the paired readout circuits 401 including the readout circuit 401 poor in characteristics is stopped. The readout circuits 401 that are arranged as redundancy circuits and positioned on the same columns as those of the readout circuits 401, the use of which is stopped, are used. An example of the switching circuit 106 that switches connections between the signal lines 301 and the readout circuits 401 from the default setting to the redundancy setting has been described above.

This can implement the photoelectric conversion device 100 in which even when signals are transferred between the readout circuits 401 to execute an arithmetic process in the readout circuits 401 including analog circuits, both the image quality and improvement of the redundancy by the remedying of a defective circuit are satisfied.

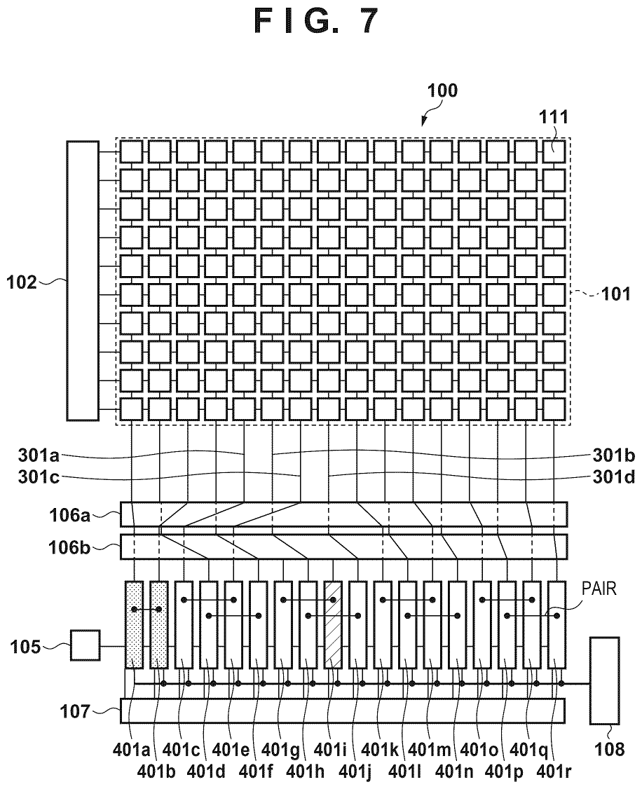

FIG. 7 is a view showing a modification of the above-described photoelectric conversion device 100. In the arrangement shown in FIG. 7, the switching circuit 106 is divided and arranged for odd-numbered columns and even-numbered columns of the pixels 111. A switching circuit 106a corresponds to the pixels 111 arranged on odd-numbered columns, and a switching circuit 106b corresponds to the pixels 111 arranged on even-numbered columns. The switching circuits 106a and 106b switch connection relationships between the signal lines 301 and the readout circuits 401 using individual external input registers. The remaining arrangement can be similar to one in the above-described embodiment, and a description thereof will be properly omitted.

In the arrangement shown in FIG. 7, 18 readout circuits 401 are arranged in the lateral direction with respect to 16 signal lines 301. The readout circuits 401a and 401b of two columns at the left end are set as redundancy circuits. Also, in the arrangement shown in FIG. 7, the switching circuit 106a controls connections between the readout circuits 401 and the signal lines 301 arranged in correspondence with the pixels 111 of odd-numbered columns of the pixel array 101. The switching circuit 106b controls connections between the readout circuits 401 and the signal lines 301 arranged in correspondence with the pixels 111 of even-numbered columns of the pixel array 101. As described above, when the pixels 111 arranged on odd-numbered columns and the pixels 111 arranged on even-numbered columns are sensitive to light beams of different colors, it is considered that signals corresponding to light beams of different colors are rarely arithmetically processed. Therefore, in the arrangement shown in FIG. 7, the switching circuit 106 is divided and arranged in correspondence with odd-numbered columns and even-numbered columns in the pixel array 101 so that the divided switching circuits can be individually controlled. Although not clearly shown in FIG. 7, the readout circuits 401a and 401b arranged as redundancy circuits can be shared between odd-numbered columns and even-numbered columns. That is, both the switching circuits 106a and 106b have a circuit arrangement in which the connection destinations of the signal lines 301 can be connected to the readout circuits 401a and 401b.

In FIG. 7, the characteristics of the hatched readout circuit 401i degrade. At the default setting of the switching circuit 106a, the signal line 301c connected to the readout circuit 401i is on an odd-numbered column, so the switching circuit 106a switches to the redundancy setting to use the readout circuits 401a and 401b arranged as redundancy circuits on two columns at the left end. The switching circuit 106b remains at the default setting on the premise that the characteristics of the readout circuit 401 do not degrade. Solid lines drawn on the switching circuit 106a shown in FIG. 7 visually represent connections between the readout circuits 401 and the signal lines 301 corresponding to the pixels 111 of odd-numbered columns. Dotted lines drawn on the switching circuit 106a represent that the signal lines 301 corresponding to the pixels 111 of even-numbered columns are not controlled by the switching circuit 106a and their connections are not switched. Similarly, solid lines drawn on the switching circuit 106b visually represent connections between the readout circuits 401 and the signal lines 301 corresponding to the pixels 111 of even-numbered columns. Dotted lines drawn on the switching circuit 106b represent that the signal lines 301 corresponding to the pixels 111 of odd-numbered columns are not controlled by the switching circuit 106b and their connections are not switched. Connections between the signal lines 301 and the readout circuits 401 at the default setting are not shown. The arrangement in FIG. 7 can be similar to an arrangement obtained by removing two of the readout circuits 401a to 401d of four columns at the left end from the arrangement in FIG. 2.

The redundancy setting shown in FIG. 7 will be described in more detail. At the default setting, the switching circuit 106a connects the signal line 301a to the readout circuit 401i. When the characteristics of the readout circuit 401i degrade, the switching circuit 106a capable of shifting the connection destinations of the signal lines 301 corresponding to the pixels 111 of odd-numbered columns is controlled using an external input register. The use of the readout circuit 401i poor in characteristics and the readout circuit 401g paired with the readout circuit 401i is stopped, and the readout circuits 401a and 401b arranged as redundancy circuits on two columns at the left end are used. The readout circuits 401a and 401b arranged as redundancy circuits can be shared between the switching circuits 106a and 106b. This arrangement can reduce the number of readout circuits 401 arranged as redundancy circuits. Therefore, the circuit scale can be reduced in comparison with the embodiment as shown in FIG. 1, and this arrangement has, for example, a merit advantageous for the layout area. Although the readout circuits 401 arranged as redundancy circuits are shared between the switching circuits 106a and 106b in the arrangement shown in FIG. 7, the arrangement is not limited to this. For example, the readout circuits 401 of four columns may be arranged as redundancy circuits without sharing the readout circuits 401 arranged as redundancy circuits between the switching circuits 106a and 106b. In the arrangement shown in FIG. 7, it is important to independently control connection relationships between the readout circuits 401 and the signal lines 301 corresponding to the pixels 111 arranged on odd-numbered columns, and connection relationships between the readout circuits 401 and the signal lines 301 corresponding to the pixels 111 arranged on even-numbered columns. This arrangement can implement the photoelectric conversion device 100 in which even when signals are transferred between the readout circuits 401 including analog circuits to execute an arithmetic process, both the image quality and improvement of the redundancy by the remedying of a defective circuit are satisfied.

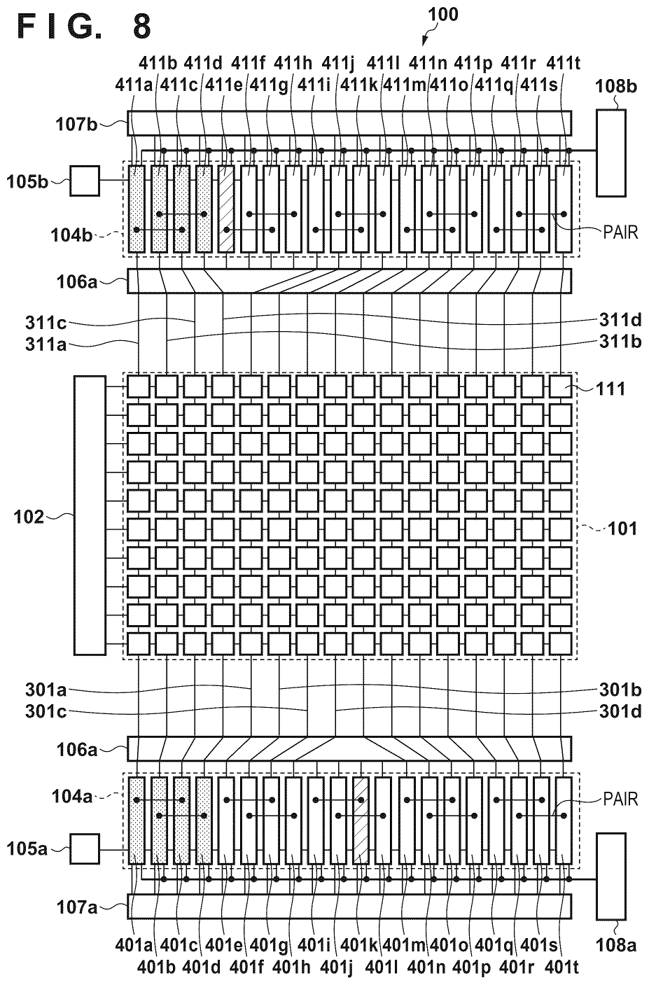

FIG. 8 is a view showing a modification of the above-described photoelectric conversion device 100. In the arrangement shown in FIG. 8, the signal lines 301, the switching circuit 106, and the readout circuits 401 described above constitute one group, and the photoelectric conversion device 100 includes a plurality of groups. More specifically, the photoelectric conversion device 100 includes a group including the signal lines 301, the switching circuit 106a, and the readout circuits 401 as the first group, and a group including signal lines 311, the switching circuit 106b, and readout circuits 411 as the second group. In this case, the pixel array 101 is arranged between a block 104a of the readout circuits 401 belonging to the first group, and a block 104b of the readout circuits 411 belonging to the second group. In accordance with these groups, counter circuits 105a and 105b, horizontal scanning circuits 107a and 107b, and digital processing circuits 108a and 108b are arranged. Although the two groups are arranged in FIG. 8, three or more groups may be arranged in the photoelectric conversion device 100. The remaining arrangement may be similar to the arrangement as shown in FIG. 1 described above, so a different arrangement will be mainly explained and a description of a similar arrangement will be properly omitted.

In the arrangement shown in FIG. 8, the readout circuits 401 and 411 of the respective groups include redundancy circuits, and the redundancy setting is possible for the respective groups by the switching circuits 106a and 106b. In the group including the signal lines 301, the switching circuit 106a, and the readout circuits 401, the signal lines 301 of 16 columns are arranged. In addition, 20 readout circuits 401 are arranged, and the readout circuits 401a to 401d of four columns at the left end are set as redundancy circuits. The example shown in FIG. 8 represents a connection in which the characteristics of the readout circuit 401k degrade, and the switching circuit 106a is controlled using an external input register or the like to switch the setting from the default setting to the redundancy setting and use the readout circuits 401a to 401d arranged as redundancy circuits. Although not shown in FIG. 8, the switching circuit 106a connects the signal line 301a to the readout circuit 401i, the signal line 301b to the readout circuit 401j, the signal line 301c to the readout circuit 401k, and the signal line 301d to the readout circuit 401l at the default setting. To the contrary, at the redundancy setting, the use of the readout circuit 401k poor in characteristics, and the readout circuit 401i paired with the readout circuit 401k is stopped. As described above, the use of a pair (readout circuits 401j and 401l) including the readout circuit 401j sandwiched between the paired readout circuits 401 including the defective readout circuit 401k is stopped. The switching circuit 106a connects the signal line 301a to the readout circuit 401e, the signal line 301b to the readout circuit 401f, the signal line 301c to the readout circuit 401g, and the signal line 301d to the readout circuit 401h. In response to this, the signal lines 301 arranged on the left side in FIG. 8 with respect to the signal line 301a are respectively connected to the readout circuits 401a to 401d arranged as redundancy circuits.

In the group including the signal lines 311, the switching circuit 106b, and the readout circuits 411, the signal lines 311 of 16 columns are arranged. Also, 20 readout circuits 411 are arranged, and the readout circuits 411a to 411d of four columns at the left end are set as redundancy circuits. The example shown in FIG. 8 represents a connection in which the characteristics of the readout circuit 411e in addition to the above-mentioned readout circuit 401k degrade, and the switching circuit 106b is controlled to switch the setting from the default setting to the redundancy setting and use the readout circuits 411a to 411d arranged as redundancy circuits. Although not shown in FIG. 8, the switching circuit 106b connects the signal line 311a to the readout circuit 411e, the signal line 311b to the readout circuit 411f, the signal line 311c to the readout circuit 411g, and the signal line 311d to the readout circuit 411h at the default setting. In contrast, at the redundancy setting, the use of the readout circuit 411e poor in characteristics, and the readout circuit 411g paired with the readout circuit 411e is stopped. As described above, the use of a pair (readout circuits 411f and 411h) including the readout circuit 411f sandwiched between the paired readout circuits 401 including the defective readout circuit 411e is stopped. The switching circuit 106b connects the signal line 311a to the readout circuit 411a, the signal line 311b to the readout circuit 411b, the signal line 311c to the readout circuit 411c, and the signal line 311d to the readout circuit 411d. That is, at the default setting, the signal lines 311a to 311d are connected to the readout circuits 411a to 411d that are arranged as redundancy circuits and are not connected to any of the signal lines 311.

When the readout circuits 401 and 411 are divisionally arranged on the lower and upper sides of the pixel array 101, as shown in FIG. 8, redundancy circuits are arranged in the respective readout circuits 401 and 411, and the switching circuits 106a and 106b corresponding to the respective readout circuits 401 and 411 are independently controlled. When the readout circuits 401 and 411 are so arranged as to sandwich the pixel array 101, as shown in FIG. 8, the readout circuits 401 and 411 are arranged physically apart from each other. It is therefore difficult to share redundancy circuits between the readout circuits 401 and 411, so redundancy circuits are arranged in the respective readout circuits 401 and 411. By independently controlling the switching circuits 106a and 106b, the number of readout circuits 401 that can be remedied can be increased, improving the yield of the photoelectric conversion device 100. The arrangement shown in FIG. 8 can also implement the photoelectric conversion device 100 in which even when signals are transferred between the readout circuits 401 and between the readout circuits 411 to execute an arithmetic process in the readout circuits 401 and 411 including analog circuits, both the image quality and improvement of the redundancy by the remedying of a defective circuit are satisfied.

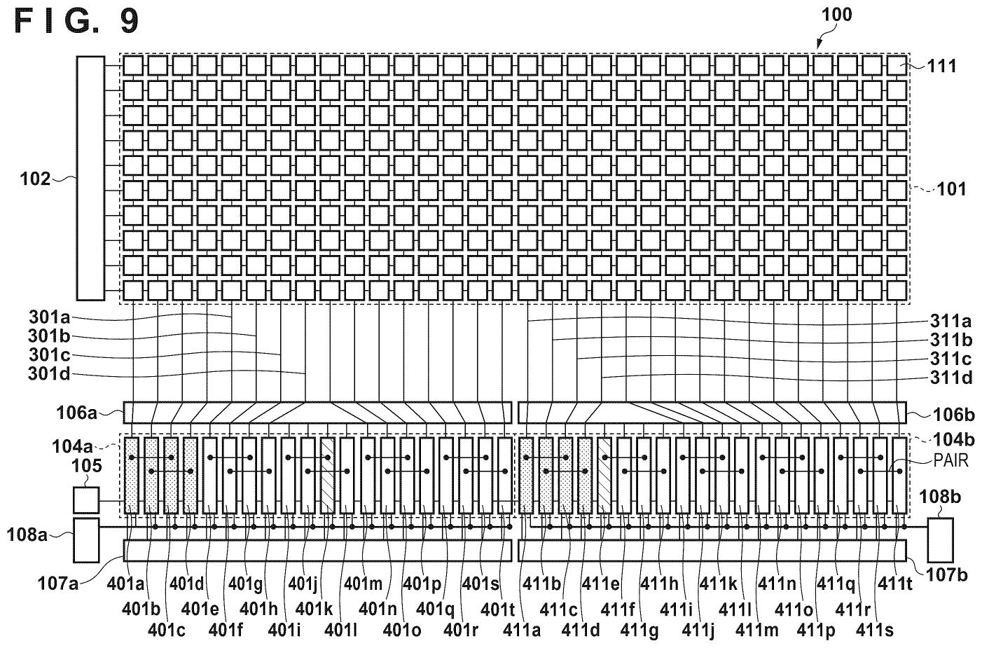

FIG. 9 is a view showing a modification of the above-described photoelectric conversion device 100. In the arrangement shown in FIG. 9, similar to the arrangement shown in FIG. 8, the photoelectric conversion device 100 includes a group including the signal lines 301, the switching circuit 106a, and the readout circuits 401 as the first group, and a group including the signal lines 311, the switching circuit 106b, and the readout circuits 411 as the second group. However, unlike the arrangement shown in FIG. 8, the block 104a of the readout circuits 401 belonging to the first group, and the block 104b of readout circuits 411 belonging to the second group are arranged to align in the row direction crossing the column direction in which the signal lines 301 and 311 extend. The counter circuit 105 is shared between the two groups. Although the two groups are arranged in FIG. 9, three or more groups may be arranged in the photoelectric conversion device 100. The remaining arrangement may be similar to the arrangement as shown in FIG. 1 or 8 described above, so a different arrangement will be mainly explained and a description of a similar arrangement will be properly omitted.

FIG. 9 shows an example in which the pixels 111 on 10 rows×32 columns are arranged. In correspondence with the pixels of 32 columns, a total of 32 signal lines 301 and 311 are arranged. Also, a total of 40 readout circuits 401 and 411 are arranged. Of the 40 readout circuits 401 and 411, 20 readout circuits arranged on the left side in FIG. 9 are the readout circuits 401 belonging to the first group, and 20 readout circuits arranged on the right side are the readout circuits 411 belonging to the second group. Of the readout circuits 401 belonging to the first group, the readout circuits 401a to 401d of four columns at the left end are arranged as redundancy circuits. Of the readout circuits 411 belonging to the second group, the readout circuits 411a to 411d of four columns at the left end are arranged as redundancy circuits. The switching circuit 106a switches connection relationships between the readout circuits 401 and the signal lines 301 corresponding to 16 pixel columns on the left side. The switching circuit 106b switches connection relationships between the readout circuits 411 and the signal lines 311 corresponding to 16 pixel columns on the right side. The switching circuits 106a and 106b can be independently controlled using external input registers or the like. Similar to the arrangement shown in FIG. 8, if the use of redundancy circuits can be individually controlled in the first and second groups, the number of readout circuits 401 and 411 that can be remedied can be increased, improving the yield.

Digital data held in the memories MEM of the readout circuits 401 belonging to the first group are sequentially read out under timing control by the horizontal scanning circuit 107a. Similarly, digital data held in the memories MEM of the readout circuits 411 belonging to the second group are sequentially read out under timing control by the horizontal scanning circuit 107b. The horizontal scanning circuits 107a and 107b are arranged for the respective groups and can independently execute readout of digital data. Thus, the readout time of digital data can be shortened, compared to a case where signals are read out from the readout circuits 401 and 411 using one horizontal scanning circuit 107. When the plurality of horizontal scanning circuits 107 are arranged, redundancy circuits can be arranged in the respective regions of the readout circuits 401 and 411 respectively scanned by the horizontal scanning circuits 107. That is, the horizontal scanning circuits 107 may be arranged in correspondence with the respective groups to which the readout circuits 401 and 411 belong. For example, a case where no redundancy circuit is set for the readout circuits 411 belonging to the second group, and the readout circuits 401a to 401d of four columns at the left end out of the readout circuits 401 belonging to the first group are shared as redundancy circuits between the two groups will be considered. In this case, at the default setting, digital data of 16 left pixel columns are transferred by the horizontal scanning circuit 107a to the digital processing circuit 108a. When the characteristics of any of the readout circuits 411 belonging to the second group degrade and the setting is switched to the above-mentioned redundancy setting, digital data of 20 left pixel columns are transferred by the horizontal scanning circuit 107a to the digital processing circuit 108a. Thus, an assumed digital process may fail unless data are exchanged between the digital processing circuits 108a and 108b after transferring the digital data. To prevent this, the respective arrangements are so provided that data of 16 left pixel columns can always be scanned by the horizontal scanning circuit 107a and data of 16 right pixel columns can always be scanned by the horizontal scanning circuit 107b.

FIG. 9 shows an example in which the characteristics of the two readout circuits 401 and 411, that is, the readout circuits 401k and 411e degrade, and shows a connection state in which the redundancy setting is applied. Although not shown in FIG. 9, the switching circuit 106a connects the signal line 301a to the readout circuit 401i, the signal line 301b to the readout circuit 401j, the signal line 301c to the readout circuit 401k, and the signal line 301d to the readout circuit 401l at the default setting. Also, the switching circuit 106b connects the signal line 311a to the readout circuit 411e, the signal line 311b to the readout circuit 411f, the signal line 311c to the readout circuit 411g, and the signal line 311d to the readout circuit 411h at the default setting.

In contrast, at the redundancy setting, the use of the readout circuit 401k poor in characteristics, and the readout circuit 401i paired with the readout circuit 401k is stopped. As described above, the use of a pair (readout circuits 401j and 401l) including the readout circuit 401j sandwiched between the paired readout circuits 401 including the defective readout circuit 401k is stopped. The switching circuit 106a connects the signal line 301a to the readout circuit 401e, the signal line 301b to the readout circuit 401f, the signal line 301c to the readout circuit 401g, and the signal line 301d to the readout circuit 401h. In response to this, the signal lines 301 arranged on the left side in FIG. 9 with respect to the signal line 301a are respectively connected to the readout circuits 401a to 401d arranged as redundancy circuits. In addition, at the redundancy setting, the use of the readout circuit 411e poor in characteristics, and the readout circuit 411g paired with the readout circuit 411e is stopped. As described above, the use of a pair (readout circuits 411f and 411h) including the readout circuit 411f sandwiched between the paired readout circuits 411 including the defective readout circuit 411e is stopped. The switching circuit 106b connects the signal line 311a to the readout circuit 411a, the signal line 311b to the readout circuit 411b, the signal line 311c to the readout circuit 411c, and the signal line 311d to the readout circuit 411d. That is, the signal lines 311a to 311d are connected to the readout circuits 411a to 411d that are arranged as redundancy circuits and are not connected to any of the signal lines 311 at the default setting.

The arrangement shown in FIG. 9 can also implement the photoelectric conversion device 100 in which even when signals are transferred between the readout circuits 401 and 411 including analog circuits to execute an arithmetic process, both the image quality and improvement of the redundancy by the remedying of a defective circuit are satisfied. As a result, the yield of the photoelectric conversion device 100 can be improved.

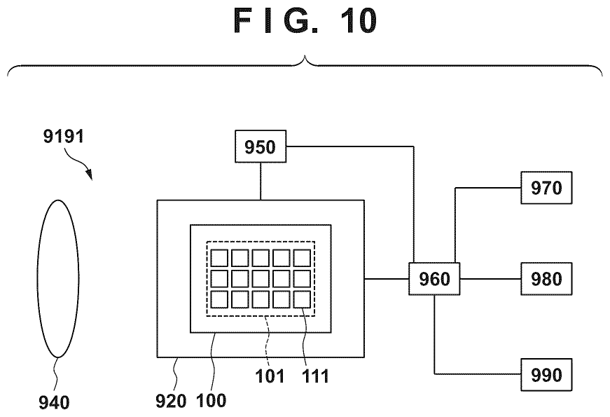

An application example of the photoelectric conversion device 100 according to the embodiment will be explained with reference to FIG. 10. FIG. 10 is a schematic view of an apparatus 9191 including the photoelectric conversion device 100. As shown in FIG. 10, the photoelectric conversion device 100 is housed in a package 920. The package 920 can include a base to which the photoelectric conversion device 100 is fixed, and a lid such as glass facing the photoelectric conversion device 100. The package 920 can further include joint members such as bonding wires and bumps that connect terminals provided on the base and pads provided on the photoelectric conversion device 100.

The apparatus 9191 can include at least one of an optical device 940, a control device 950, a processing device 960, a display device 970, a storage device 980, and a mechanical device 990. The optical device 940 is implemented by, for example, a lens, a shutter, and a mirror. The control device 950 controls the photoelectric conversion device 100. The control device 950 is, for example, a semiconductor device such as an ASIC.

The processing device 960 processes a signal output from the photoelectric conversion device 100. The processing device 960 is a semiconductor device such as a CPU or an ASIC for forming an analog front end (AFE) or a digital front end (DFE). The display device 970 is an EL display device or a liquid crystal display device that displays information (image) obtained by the photoelectric conversion device 100. The storage device 980 is a magnetic device or a semiconductor device that stores the information (image) obtained by the photoelectric conversion device 100. The storage device 980 is a volatile memory such as an SRAM or a DRAM, or a nonvolatile memory such as a flash memory or a hard disk drive.

The mechanical device 990 includes a moving or propulsion unit such as a motor or an engine. In the apparatus 9191, the signal output from the photoelectric conversion device 100 is displayed on the display device 970 or transmitted to an external device by a communication device (not shown) included in the apparatus 9191. Hence, the apparatus 9191 may further include the storage device 980 and the processing device 960 in addition to the memory circuits and arithmetic circuits included in the photoelectric conversion device 100. The mechanical device 990 may be controlled based on the signal output from the photoelectric conversion device 100.

In addition, the apparatus 9191 is suitable for an electronic apparatus such as an information terminal (for example, a smartphone or a wearable terminal) which has a shooting function or a camera (for example, an interchangeable lens camera, a compact camera, a video camera, or a monitoring camera). The mechanical device 990 in the camera can drive the components of the optical device 940 in order to perform zooming, an in-focus operation, and a shutter operation. Alternatively, the mechanical device 990 in the camera can move the photoelectric conversion device 100 in order to perform an anti-vibration operation.

Furthermore, the apparatus 9191 can also be applied to an onboard camera mounted in a transportation apparatus such as a vehicle, a ship, an airplane, or an industrial robot. The mechanical device 990 in the transportation apparatus can be used as a moving device. The apparatus 9191 as the transportation apparatus is suitable for a device that transports the photoelectric conversion device 100 or a device that uses an image capturing function to assist and/or automate driving (steering). The processing device 960 for assisting and/or automating driving (steering) can perform, based on the information obtained by the photoelectric conversion device 100, processing for operating the mechanical device 990 as a moving device. The apparatus 9191 incorporating the photoelectric conversion device 100 can be widely applied to an apparatus using object recognition such as an intelligent transport system (ITS), in addition to the transportation apparatus. Alternatively, the apparatus 9191 may be a medical apparatus such as an endoscope, a measurement apparatus such as a distance measurement sensor, an analysis device such as an electron microscope, or an office apparatus such as a copy machine.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074042, filed Apr. 30, 2024, which is hereby incorporated by reference herein in its entirety.

What is claimed is:

1. A photoelectric conversion device comprising:
a pixel array including a plurality of pixels arranged to constitute a plurality of rows and a plurality of columns;
a plurality of signal lines configured to read out a signal from the pixel array;
a plurality of readout circuits arranged to be larger in number than the plurality of signal lines; and
a switching circuit configured to switch connections between the plurality of signal lines and the plurality of readout circuits,
wherein the plurality of readout circuits include a first readout circuit, a second readout circuit, a third readout circuit, and a fourth readout circuit, the first readout circuit is configured to output a signal based on signals respectively supplied to the first readout circuit and the second readout circuit, and the third readout circuit is configured to output a signal based on signals respectively supplied to the third readout circuit and the fourth readout circuit,
the plurality of signal lines include a first signal line and a second signal line, and
the switching circuit is configured to switch a setting between a first setting at which the switching circuit connects the first signal line to the first readout circuit and connects the second signal line to the second readout circuit, and a second setting at which the switching circuit connects the first signal line to the third readout circuit and connects the second signal line to the fourth readout circuit.

2. The photoelectric conversion device according to claim 1, wherein when the first readout circuit does not satisfy a predetermined characteristic, the switching circuit is configured to switch the setting from the first setting to the second setting.

3. The photoelectric conversion device according to claim 1, wherein at the first setting, any signal line of the plurality of signal lines is not connected to the third readout circuit and the fourth readout circuit.

4. The photoelectric conversion device according to claim 1, wherein the plurality of readout circuits further include a fifth readout circuit and a sixth readout circuit, and the fifth readout circuit is configured to output a signal based on signals respectively supplied to the fifth readout circuit and the sixth readout circuit,
the plurality of signal lines further include a third signal line and a fourth signal line,
at the first setting, the switching circuit is configured to connect the third signal line to the third readout circuit, and connects the fourth signal line to the fourth readout circuit, and
at the second setting, the switching circuit is configured to connect the third signal line to the fifth readout circuit, and connects the fourth signal line to the sixth readout circuit.

5. The photoelectric conversion device according to claim 1, wherein the plurality of readout circuits further include a seventh readout circuit and an eighth readout circuit, and the seventh readout circuit is arranged between the first readout circuit and the second readout circuit,
the plurality of signal lines further include a fifth signal line, and
the switching circuit is configured to connect the fifth signal line to the seventh readout circuit at the first setting, and is configured to connect the fifth signal line to the eighth readout circuit at the second setting.

6. The photoelectric conversion device according to claim 5, wherein at the first setting, any signal line of the plurality of signal lines is not connected to the eighth readout circuit.

7. The photoelectric conversion device according to claim 5, wherein the plurality of readout circuits further include a ninth readout circuit,
the plurality of signal lines further include a sixth signal line, and
the switching circuit is configured to connect the sixth signal line to the eighth readout circuit at the first setting, and is configured to connect the sixth signal line to the ninth readout circuit at the second setting.

8. The photoelectric conversion device according to claim 1, wherein the plurality of readout circuits further include a seventh readout circuit, an eighth readout circuit, a 10th readout circuit, and an 11th readout circuit, the seventh readout circuit is arranged between the first readout circuit and the second readout circuit and configured to output a signal based on signals respectively supplied to the seventh readout circuit and the 10th readout circuit, and the eighth readout circuit is configured to output a signal based on signals respectively supplied to the eighth readout circuit and the 11th readout circuit,
the plurality of signal lines further include a fifth signal line and a seventh signal line,
at the first setting, the switching circuit is configured to connect the fifth signal line to the seventh readout circuit, and connects the seventh signal line to the 10th readout circuit, and
at the second setting, the switching circuit is configured to connect the fifth signal line to the eighth readout circuit, and connects the seventh signal line to the 11th readout circuit.

9. The photoelectric conversion device according to claim 1, wherein the plurality of readout circuits further include a 12th readout circuit,
the plurality of signal lines further include an eighth signal line,
the second readout circuit is arranged between the first readout circuit and the third readout circuit, the third readout circuit is arranged between the second readout circuit and the fourth readout circuit, and the first readout circuit is arranged between the 12th readout circuit and the second readout circuit, and
the switching circuit is configured to connect the eighth signal line to the 12th readout circuit at the first setting and the second setting.

10. The photoelectric conversion device according to claim 1, wherein each signal line is arranged in correspondence with each column of the plurality of pixels.

11. The photoelectric conversion device according to claim 1, wherein the plurality of signal lines are arranged by a predetermined number of lines in correspondence with each column of the plurality of pixels.

12. The photoelectric conversion device according to claim 1, wherein the plurality of signal lines, the switching circuit, and the plurality of readout circuits constitute one group, and
the photoelectric conversion device includes a plurality of groups including a first group and a second group.

13. The photoelectric conversion device according to claim 12, wherein the pixel array is arranged between a block of the plurality of readout circuits belonging to the first group, and a block of the plurality of readout circuits belonging to the second group.

14. The photoelectric conversion device according to claim 12, wherein a block of the plurality of readout circuits belonging to the first group, and a block of the plurality of readout circuits belonging to the second group are arranged to align in a row direction crossing a column direction in which the plurality of signal lines extend.

15. The photoelectric conversion device according to claim 1, wherein an input of the readout circuit not connected to any signal line of the plurality of signal lines, out of the plurality of readout circuits, is connected to a fixed potential.

16. The photoelectric conversion device according to claim 1, wherein the first readout circuit is configured to perform at least one of an addition process and a subtraction process based on a signal supplied to the first readout circuit and a signal supplied to the second readout circuit, thereby outputting the signal based on the signals respectively supplied to the first readout circuit and the second readout circuit.

17. The photoelectric conversion device according to claim 16, wherein the third readout circuit is configured to perform at least one of an addition process and a subtraction process based on a signal supplied to the third readout circuit and a signal supplied to the fourth readout circuit, thereby outputting the signal based on the signals respectively supplied to the third readout circuit and the fourth readout circuit.

18. The photoelectric conversion device according to claim 16, wherein the first readout circuit is configured to weight a signal supplied to the first readout circuit and a signal supplied to the second readout circuit.

19. The photoelectric conversion device according to claim 1, wherein the first readout circuit is configured to switch and perform an operation of outputting a signal supplied to the first readout circuit, and an operation of outputting a signal based on signals respectively supplied to the first readout circuit and the second readout circuit.

20. The photoelectric conversion device according to claim 1, wherein the third readout circuit is configured to switch and perform an operation of outputting a signal supplied to the third readout circuit, and an operation of outputting a signal based on signals respectively supplied to the third readout circuit and the fourth readout circuit.

21. The photoelectric conversion device according to claim 19, wherein the third readout circuit is configured to switch and perform an operation of outputting a signal supplied to the third readout circuit, and an operation of outputting a signal based on signals respectively supplied to the third readout circuit and the fourth readout circuit.

22. An apparatus comprising:
the photoelectric conversion device according to claim 1; and
a processing device configured to process a signal output from the photoelectric conversion device.
